(19) United States
(12) Patent Application Publication
(10) Pub. No.: US 2018/0308055 A1
(43) Pub. Date: Oct. 25, 2018

(54) SYSTEM AND METHOD FOR QUEUE TIME MANAGEMENT

(71) Applicant: Shawn S. KORIN, Saint-Laurent (CA)

(72) Inventor: Shawn S. KORIN, Saint-Laurent (CA)

(21) Appl. No.: 15/493,056

(22) Filed: Apr. 20, 2017

(51) Int. Cl. G06Q 10/10; G06F 17/30; G06K 7/14

(52) U.S. Cl. CPC G06Q 10/109; G06K 7/1417; G06F 17/30174; G06F 17/30864

(57) ABSTRACT

A method for queue time management, which includes transmitting queue data to an internet database. The queue data includes an estimated queue wait time for a customer to receive a service from a service provider at a service provider location. On an internet connecting device that is located away from the service provider, the queue data is accessed from the internet database. The queue data is continuously updated, so that when the customer requests the queue data, the updated queue data is calculated and displayed on the internet connecting device. The customer is informed of the time until the service provider can provide the service at the service provider location.

### TECHNICAL FIELD

The present relates to a system and method for queue time management, and more particularly to a system and method for alerting a customer located remote from a service provider when it is time to be served.

### BACKGROUND

Nowadays people spent a large amount of time waiting in queues. Queuing is generally necessary to obtain certain services, for example, medical care at a primary care health clinic or at a hospital; obtaining passports or visas; or waiting for a table at a popular restaurant. However, for businesses that rely on high volume customer traffic, queuing can be economically inefficient because it relies largely on the customers' willingness to wait for an unknown period before they are served. Indeed, a number of customers or potential customers waiting in a long queue may take their business elsewhere or avoid that business altogether under the assumption that the long wait times are normal. Furthermore, queuing can be an unproductive use of time, especially when customers who may wish to temporarily leave the queue or immediate area to do other errands, fears losing their place in the queue. The reasons for this are either because the queue moves too quickly while they are away or they fail to hear when it is their turn to be served. In all cases, the length of waiting time is generally guesswork largely because service or product providers have no practical way of communicating or interacting with their waiting customers.

Conventional systems, which are available to manage the wait time waiting customers queue for service, and notify them when service is ready, currently have no way of interacting with the waiting customer to let them know when it is the customer's turn to be served. Such systems include: i) physical queues in which customers gather in a small area or in an area roped off from other customers, which is awkward, unappealing, and uncomfortable for customers; ii) intercom paging systems in which customers' names are called out over a loud speaker to a crowd of waiting customers, which can be cumbersome to manage because some guests may not hear the page the first time their names are called. This could also deteriorate the atmosphere for customers who are currently receiving service; or iii) the older system of “Take a number” in which each customer is given a number and an elevated display shows the “Now Serving” number to a crowd of customers. This system has similar problems compared to the intercom system with regards to crowd management. A very expensive queuing system, which is used by large hospitals, is known in which a person in a queue will receive a text message when his/her turn is “X” positions away. This system notifies purely based on position in line, and not related to time. Furthermore, the user cannot proactively check his/her place in the queue, nor is there a way to ensure that the recipient received the text message.

Disadvantageously, none of the conventional systems permit the service provider to interact with waiting customers, nor do they allow verification that waiting individuals have received notification that service is available. Furthermore, none of the conventional systems permit the customer queuing to physically leave the queue without the possibility of the person losing their place in the queue. Moreover, in existing wait-line management systems, the displays used are incremented as stand-alone units, and do not update any external server, i.e. they have no use outside of physical view at the location.

Thus, there is a need for an improved queue wait time management system and method that is easy to use for both the customer and service provider, and which provides real-time queue information.

### BRIEF SUMMARY

I have designed a system and method that significantly reduces, or essentially eliminates, the problems discussed above. To achieve this, I have designed a new and unobvious system in which a mobile phone device requests access to an internet database containing the information uploaded by a physical number display so that the customer does not have to queue on location at the service provider. The physical number display synchronizes with computer database users to see their place in a queue from a remote location.

Accordingly, in one embodiment there is provided a method for queue time management, the method comprising:

a) transmitting queue data to an internet database, the queue data including an estimated queue wait time for a customer to receive a service from a service provider at a service provider location; and

b) on an internet connecting device located remote from the service provider, accessing the queue data from the internet database, the queue data being continuously updated, so that when the customer requests the queue data, the updated queue data is calculated and displayed on the internet connecting device, the customer being informed of the time until the service provider can provide the service at the service provider location.

In one example, the method further includes from an input device, sending an initiation command to a computation machine to set a display to default queue data and transmitting the default queue data to the internet database.

In another example, the method further includes continuously updating and synchronizing the queue data at the internet database so that when the customer requests the queue data, the updated queue data is calculated and displayed on the customer's internet connection device.

In yet another example, the method further includes accessing the internet database at the customer internet connection device by scanning a QR code; and receiving updated queue data from the internet database.

In another example, the input device is wirelessly connected to the computational machine.

In another example, the input device is connected by wires to the computational machine.

In another example, the internet connecting device is a mobile electronic device. The mobile electronic device is a smart phone or a tablet.

In another example, the customer receives an alert when they must return to the queue. The alert is provided by way of geolocation.

In another example, the queue data includes a customer number, a current number and an estimated queue wait time for the customer, the estimated queue wait time being the estimated time for a customer to receive a service from a service provider at a service provider location

Accordingly in another embodiment, there is provided a system for queue time management, the system comprising:

a service provider display;

a computation machine connected to the display;

an internet database for receiving queue data, the queue data including an estimated queue wait time for a customer to receive a service from a service provider at a service provider location from the display; and

an internet connecting device located remote from the service provider, the device accessing the queue data from the internet database, the queue data being continuously updated, so that when the customer requests the queue data, the updated queue data is calculated and displayed on the internet connecting device, the customer being informed of the time until the service provider can provide the service at the service provider location.

In one example, the system further includes: an input device for sending an initiation command to the computation machine to set the display to default queue data and for transmitting the default queue data to the internet database.

Accordingly, in another embodiment, there is provided a computer system for generating a managing queue wait time, the system comprising:

a database having stored therein a dictionary;

a display screen;

a processor and non-transient memory having stored thereon instructions which when activated cause the following steps:

a) transmitting queue data to an internet database, the queue data including an estimated queue wait time for a customer to receive a service from a service provider at a service provider location; and

b) on an internet connecting device located remote from the service provider, accessing the queue data from the internet database, the queue data being continuously updated, so that when the customer requests the queue data, the updated queue data is calculated and displayed on the internet connecting device, the customer being informed of the time until the service provider can provide the service at the service provider location.

Accordingly, in yet another embodiment, there is provided one or more computer-readable media storing computer-executable instructions that, when executed by at least one processor, configure the at least one processor to:

manage queue wait time by

a) transmitting queue data to an internet database, the queue data including an estimated queue wait time for a customer to receive a service from a service provider at a service provider location; and

b) on an internet connecting device located remote from the service provider, accessing the queue data from the internet database, the queue data being continuously updated, so that when the customer requests the queue data, the updated queue data is calculated and displayed on the internet connecting device, the customer being informed of the time until the service provider can provide the service at the service provider location.

### BRIEF DESCRIPTION OF THE DRAWINGS

These and other features of that described herein will become more apparent from the following description in which reference is made to the appended drawings wherein:

FIG. 1 is a schematic diagram showing an embodiment of a queue time management system;

FIG. 2 is a block diagram showing initiation, incrementation and synchronization steps of a service provider computational machine; and

FIG. 3 is a block diagram showing initiation and viewing steps of queue data on an internet connection device.

### DETAILED DESCRIPTION

### Definitions

Unless otherwise specified, the following definitions apply:

The singular forms “a”, “an” and “the” include corresponding plural references unless the context clearly dictates otherwise.

As used herein, the term “comprising” is intended to mean that the list of elements following the word “comprising” are required or mandatory but that other elements are optional and may or may not be present.

As used herein, the term “consisting of” is intended to mean including and limited to whatever follows the phrase “consisting of”. Thus, the phrase “consisting of” indicates that the listed elements are required or mandatory and that no other elements may be present.

Certain embodiments of my design are described below with reference to systems, methods, apparatuses, and/or computer program products according to example embodiments of the design. It will be understood by one skilled in the art that one or more of the elements or blocks described below can be implemented manually or, in one example, by computer-executable program instructions. Likewise, some blocks of the block diagrams and flow diagrams may not necessarily need to be performed in the order presented, or may not necessarily need to be performed at all, according to some embodiments of the design. Further, the number of elements or blocks described below can be fewer or greater, and may include similar or other functions according to various embodiments.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

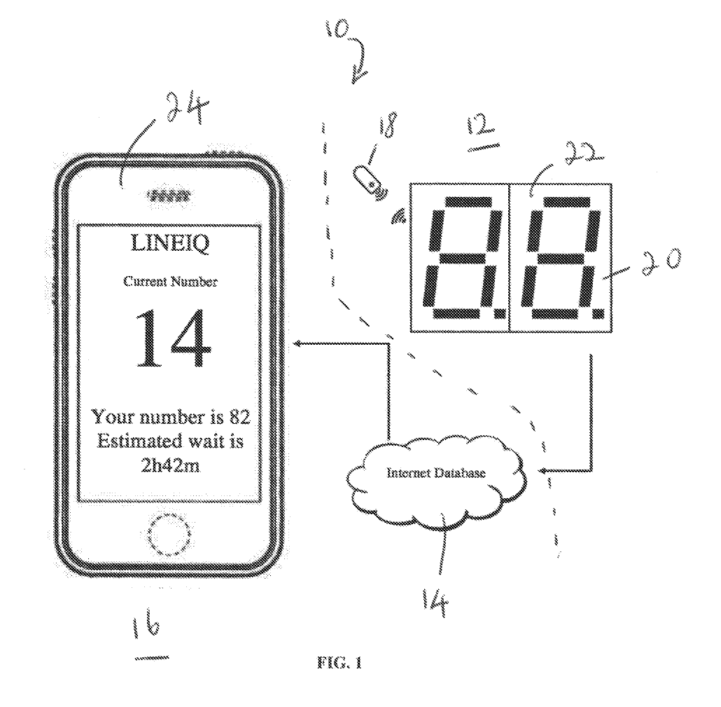

Referring now to FIG. 1, a system for queue time management is shown generally at 10. Broadly speaking, the system 10 includes a service provider area 12, an internet database 14 and a customer area 16. In the example shown, the customer area 16 is located remote from the service provider area 12.

Still referring to FIG. 1, at the service provider area 12, an input device 18 is connected, either wirelessly or via a wire, to a computational machine 20 and a display screen 22. When an initiation command is sent from the input device 18 to the computational machine 20, the number displayed on the display screen 22 is set to “0”. This is a default setting. The setting “0” is pushed (transmitted) to the internet database 14. When the service provider is ready to begin incrementing the number displayed, and serve the first customer (or client), the service provider uses the input device 18 to increment the number to, for example, “1”. This number will be shown on the display screen 22 and be pushed to the internet database 14.

Still referring to FIG. 1, the display screen 22 typically includes one or multiple display screens, which are connected to one or more output ports located on the computational machine 20 which runs a program that permits number incrementation and synchronizes with a database server located offsite away from the service provider area 12.

Still referring to FIG. 1, a customer in the customer area 16 has a hand-held electronic mobile internet connection device 24 such as a smartphone, a tablet and the like. The customer uses a mobile application to query the internet database 14 to obtain the number displayed on the 7-segment display screen 22. In one example, a mobile phone device requests access to the internet database 14 containing information uploaded by the physical number display screen 22 thereby avoiding having to queue on location at the service provider area 12.

My simple, yet effect system overcomes the difficulties found with conventional wait-line implementations, in which displays are typically incremented as standalone units, and are not designed to allow an external server to be updated. They are useless if the customer leaves the immediate viewing area of the screen. Furthermore, standard numerical waiting line implementations are operated locally, either through a physical display or through a television/LCD monitor, but they have no remote viewing and tracking capabilities. My system adds a synchronization component with an external server, which now permits remote monitoring of the number being displayed from a location remote therefrom. My system uses a physical component and a logic component.

Broadly speaking, the system 10 includes 1) the display screen 22, which will display the current number in the queue (i.e. “now serving”); 2) the computational device 20 which will handle: a) pushing the current number to the display, and b) pushing the current number to the remote database via the internet; 3) the input device 18 which will allow the service provider to change (increment/decrement) the number appearing on the screen and remote database; and 4) a power source. All of the components a packaged together into a physical device, such as a hand-held electronic mobile device for example, a smartphone, a tablet and the like.

### 1) Display Screen

As best seen in FIG. 1, the display screen 22 consists of an LED, numerical only display, or a television or other monitor display, connected via an interface such as HDMI, with the purpose of displaying the current number on screen.

### 2) Computational Device

The computational machine 22 is the driver and controller of both the displays and the connection to the internet database 14. It also handles input commands from the user via an I/O interface (either wired or wireless) to increment the number on display.

The controller holds a register in a non-transitory memory, containing a number, which defaults to 0. When powered on, this default value will be outputted to the physical display and simultaneously uploaded to the internet database. The system will also take note of the time this value was initialized. When the user input requests an increment of the number, the controller will simultaneously update the physical display and internet database. It will also take note of the time this change was initiated in order to determine the wait time between numbers.

### 3) Input Device

The input device 14 is the method the service provider can increment or decrement the number being displayed on the screen 22. This consists of either a wired button, or wireless (IR, RF, internet) transmission of a user action, that results in the number displayed incrementing or decrementing.

### 4) Power Source

The input device 14, the computational machine 20 and the display 22 include a power source, which can either be wired or battery powered.

### Operation of the System

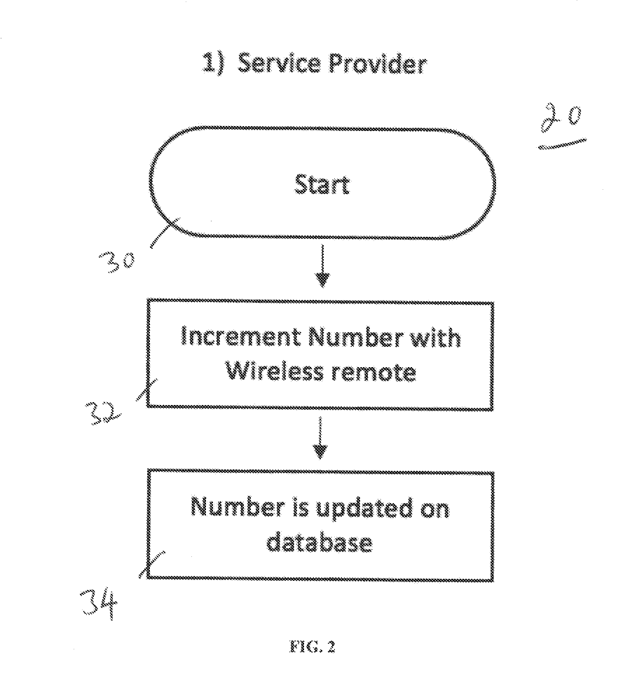

Referring now to FIGS. 1 through 3, the logic component of the system 10 will be described. The computational machine 20 includes at least one processor and a non-transient memory in the form of one or more computer-readable media, on which are stored computer-executable instructions that, when executed by the processor, configures the processor to begin managing the queue wait time. Referring to FIG. 2, the service provider begins the initiation at start block 30. The computer-executable instructions are then activated which cause, at block 32, queue data to be wirelessly transmitted from the service provider to the internet database 14. The queue data, which is displayed on the display 22, includes a customer number; a current number and an estimated queue wait time for the customer displayed incrementally. The estimated queue wait time is the estimated time for the customer to receive a service from the service provider at the service provider location (area). At block 34, as incrementation occurs, the queue data is updated in the internet database 14. At block 34, the customer can access the internet database 14, while the service provider displays the queue data. The service provider location is generally remote from the internet connection device.

The queue data is continuously updated by synchronizing the queue data with the internet database 14 so that so that when the customer requests the queue data, the updated queue data is calculated and displayed on the customer's internet connection device. The customer is informed of the time he/she must wait until the service provider can provide the service at the service provider location (area).

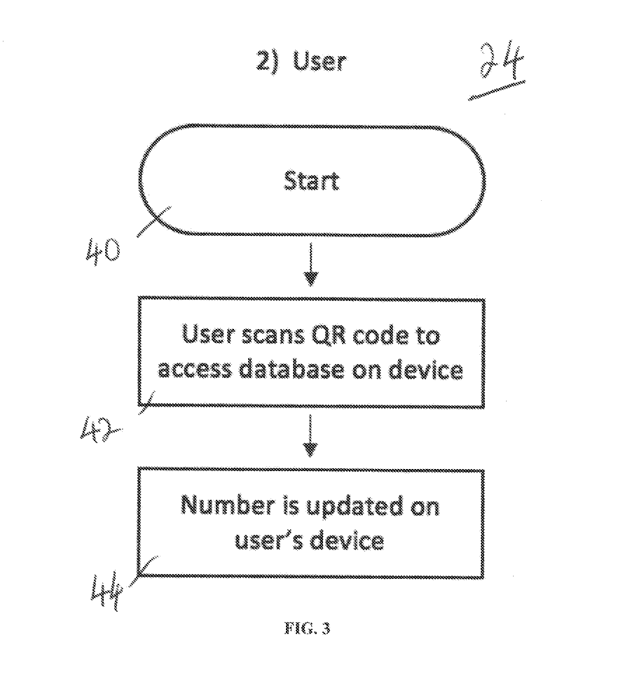

Referring to FIG. 3, the internet connection device is initiated at block 40. At block 42, the customer scans a QR code to provide access to the internet database 14 and to view the queue date on the internet connection device. The QR code is intended to mean a Quick Response code, which is a 3-Dimensional barcode known to those skilled in the art. The QR code can be simplified as a ‘barcode’ or an internet link. The QR code contains a website or some other information that can be transmitted to the device. At block 44, the customer sends a request to the internet database 14 to access updated queue data. The updated queue data will show the current number, the customer number and the estimated wait time before service is provided.

When the device is powered, the system initializes, and the number will be set to the default value of 0. This number will be shown on the display, and be pushed (transmitted) to the internet database.

When a service provider is ready to increment the number (and serve the first customer), the service provider uses the input device to increment the number. This number will be shown on the display and be transmitted to the internet database.

The user sees the display physically, or views the display on an internet-connection device, such as a mobile phone, in order to determine when it is their turn in the queue.

Advantageously, my system, unlike conventional take-a-number queue systems, provides customers and merchants with a smartphone-based application to keep track of their place in the queue. Indeed, the system is useful for small to medium sized businesses, as they typically do not have the resources required to develop such a system, and can benefit the most from the analytics the system will provide.

Furthermore, the system addresses numerous problems with current systems. For example, from the customer perspective, they can make efficient use of their time, and not have to wait in waiting rooms. There is a fair an orderly queue system where people have to be present. The system uses an easy-to-use smartphone based application for convenience, and the customer immediately receive alerts when they must return to the queue with the aid of geolocation.

Merchants (service providers) using my system can now have access to an easy to use, inexpensive method of improving their customer satisfaction, and to optimize use of their waiting space. The service providers can now optimize their staff selection, and have access to analytical information of their clients, especially historical business trends.

The customers have free of charge access to view the current status of the queue, while at a nominal fee, offer premium features, such as estimated wait time and reminder notifications. Additionally, merchants can optionally pay a subscription fee to gain access to analytics, such as average wait times and number of customers, and be able to compare various time periods to see how their business is performing.

Merchants will benefit from happier customers, less full waiting rooms, and analytical data that will show customer wait data to predict when more staff is needed.

Moreover, the merchants do not have to provide any electronic devices to waiting customers because the customers provide their own phones.

The system wherein customers do not have to remain on-premises or wait in crowded waiting areas.

Merchants can track customer responses to collect business operation metrics.

### Other Embodiments

From the foregoing description, it will be apparent to one of ordinary skill in the art that variations and modifications may be made to the embodiments described herein to adapt it to various usages and conditions.

I claim:

1. A method for queue time management, the method comprising:
a) transmitting queue data to an internet database, the queue data including an estimated queue wait time for a customer to receive a service from a service provider at a service provider location; and
b) on an internet connecting device located remote from the service provider, accessing the queue data from the internet database, the queue data being continuously updated, so that when the customer requests the queue data, the updated queue data is calculated and displayed on the internet connecting device, the customer being informed of the time until the service provider can provide the service at the service provider location.

2. The method, according to claim 1, further includes:
from an input device, sending an initiation command to a computation machine to set a display to default queue data and transmitting the default queue data too the internet database.

3. The method, according to claim 1, further includes:
continuously updating and synchronizing the queue data at the internet database so that when the customer requests the queue data, the updated queue data is calculated and displayed on the customer's internet connection device.

4. The method, according to claim 1, further includes:
accessing the internet database at the customer internet connection device by scanning a QR code; and
receiving updated queue data from the internet database.

5. The method, according to claim 1, in which the input device is wirelessly connected to the computational machine.

6. The method, according to claim 1, in which the input device is connected by wires to the computational machine.

7. The method, according to claim 1, in which the internet connecting device is a mobile electronic device.

8. The method, according to claim 7, in which the mobile electronic device is a smart phone or a tablet.

9. The method, according to claim 1, in which customer receives an alert when they must return to the queue.

10. The method, according to claim 9, in which the alert is provided by way of geolocation.

11. The method, according to claim 1, in which the queue data includes a customer number, a current number and an estimated queue wait time for the customer, the estimated queue wait time being the estimated time for a customer to receive a service from a service provider at a service provider location

12. A system for queue time management, the system comprising:
a service provider display;
a computation machine connected to the display;
an internet database for receiving queue data, the queue data including an estimated queue wait time for a customer to receive a service from a service provider at a service provider location from the display; and
an internet connecting device located remote from the service provider, the device accessing the queue data from the internet database, the queue data being continuously updated, so that when the customer requests the queue data, the updated queue data is calculated and displayed on the internet connecting device, the customer being informed of the time until the service provider can provide the service at the service provider location.

13. The system, according to claim 12, further includes:
an input device for sending an initiation command to the computation machine to set the display to default queue data and for transmitting the default queue data to the internet database.
